(19) United States
(12) Patent Application Publication
(10) Pub. No.: US 2022/0189344 A1
(43) Pub. Date: Jun. 16, 2022

(54) Expandable Door Hanger

(71) Applicant: Scott Svidergol, Newport Beach, CA (US)

(72) Inventor: Scott Svidergol, Newport Beach, CA (US)

(21) Appl. No.: 17/119,983

(22) Filed: Dec. 11, 2020

(51) Int. Cl. G09F 1/04; B42D 15/04; A44B 13/00

(52) U.S. Cl. CPC G09F 1/04; A44B 13/0064; B42D 15/045

(57) ABSTRACT

An expandable door hanger with an upper hanging portion with a slit leading to a void for hanging on a door knob or handle and with a lower portion comprising two or three panels, one of which is contiguous with the upper section, where the other lower panel or panels are foldable over or around the lower panel contiguous with the upper portion to form an expandable door hanger.

### CROSS-REFERENCE TO RELATED APPLICATIONS

None

### STATEMENT REGARDING FEDERALLY SPONSORED RESEARCH OR DEVELOPMENT

Not Applicable

### TECHNICAL FIELD

The invention relates to the field of door hangers used to convey information, advertising, or other notices on doors.

### BACKGROUND OF THE INVENTION

A door hanger (or “doorhanger” or “door-hanger”) is a small sign cut to be hung on the door of residences, hotel rooms, or other places where one seeks to advertise or convey notice.

Door hangers are generally made from a paper, plastic, or cardboard base on which is printed relevant information. They typically have cut leading to a central hole that slides over a door knob or handle, permitting them to be hung from most types of doors.

Two main types of door hangers are those hung by a third-parties, generally for advertising or similar purposes, and those used by an occupant or facility to convey information (such as “Do Not Disturb”) to others. The latter are typically designed for repeated use as the occasion requires and are often seen in hotels and other places of lodging as a means for guests to communicate with staff, while the former are generally intended for a single use to provide information to an occupant.

Door hangers provided by third-parties are commonly used as an advertising vehicle in competition with direct mail, sometimes referred to as “direct to door advertising.” This type of advertising offers advantages over traditional direct mail in that the impression is “guaranteed,” because the occupant must interact with the hanger. Also, there is generally only one message instead of a variety of coupons or notices, which highlights the information the advertiser wishes to convey. Additionally, door hangers can readily incorporate coupons or other information, which may be detachable, of potential interest to occupants.

However, advertising door hangers are generally of limited width, often around 4 inches, and have an elongated rectangular shape, thus restricting the information they can present and convey. This limits the ability of advertisers such as realtors to provide impressive photographs of their listings or merchants to present full menus or a variety of coupons. While such information can be provided by means of large flyers, these are difficult to affix to a door and lack the aesthetic and utilitarian advantages of door hangers.

### SUMMARY OF THE INVENTION

Applicant has invented an expandable door hanger that enables advertisers and others parties to present and display significantly more information and/or larger photographs than is possible with a traditional door hanger.

In one embodiment, the door hanger of the present invention has an upper section with a slit leading to a hollow or void for hanging on a door knob or handle. The lower portion, however, is comprised of three separate panels, a center panel of the same width as and continuous with the upper portion and two side panels that are cut away from the upper section and which can be folded over the center panel to create an expandable door hanger with significantly larger area than traditional door hangers, enabling the presentation of more impressive photographs or other information. Because the side sections are cut away from the upper section, they can be folded over the center of the hanger without interfering with operation of slit and hole used to hang the door hanger.

Optionally, the side panels of the door hanger of the present invention can be secured with a dab of glue, a sticker, hook and loop fastener, or other matter to maintain the hanger in a slim, closed position until opened by a customer.

In a preferred embodiment, the door hanger of the present invention is printed on heavier card stock than traditional single-panel door hangers, which are made from 20 lb to 32 lb paper stock. The inventor has determined that heavier paper stock, between 50 lb and 80 lb, imparts rigidity to the hanger, allows for more secure folding of the side panels, and offers a more impressive presentation.

The door hanger may optionally be printed on both sides, either with two full pages that display an image or other information across all three panels, one full page and three small panel pages, or some combination. Optionally, the door hanger may be printed with a single image, such as a menu, across the front and back that includes all six panels.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 illustrates a front view of an expandable door hanger according to an aspect of the present invention in a folded state.

FIG. 2 illustrates a front view of an expandable door hanger according to an aspect of the present invention in a partially unfolded state.

FIG. 3 illustrates a front view of an expandable door hanger according to an aspect of the present invention in an unfolded state.

FIG. 4 illustrates a front view of an expandable door hanger according to an aspect of the present invention hung on a door.

### DETAILED DESCRIPTION OF THE DRAWINGS

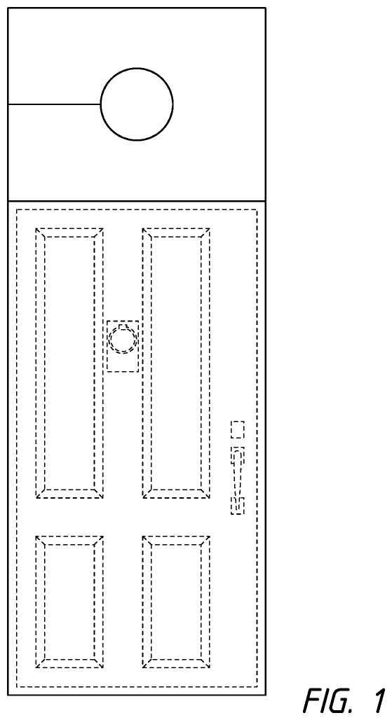

One embodiment of the present invention is illustrated in FIG. 1, which shows a front view of the door hanger in a folded state. In a folded state, the door hanger is compact and can be readily hung from most door handles or knobs.

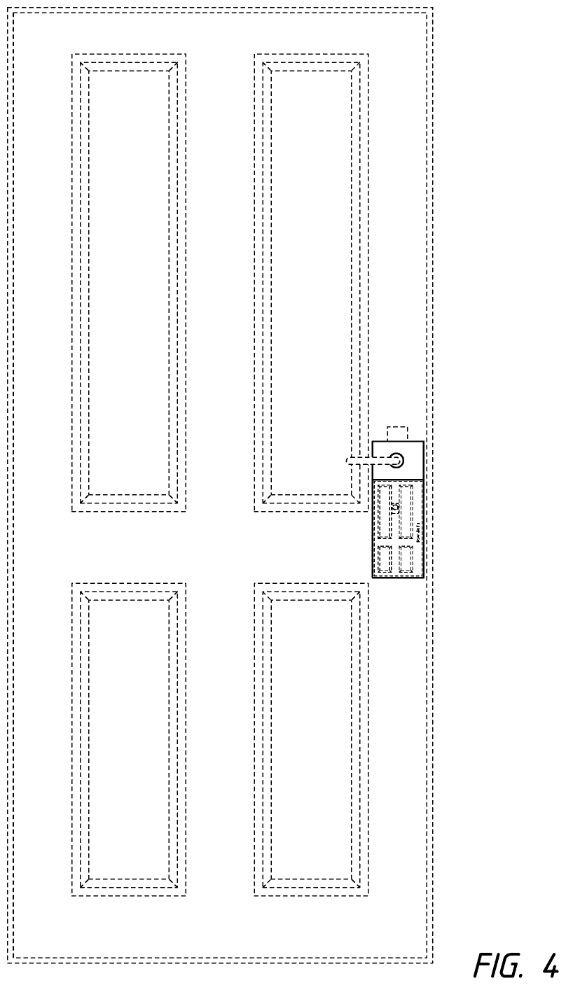

Unlike standard flyers, which are 8×10 inches or similar dimensions, the folded door hanger fits within the frame of standard doors as shown in FIG. 4, the knobs of which are recessed in relation to surrounding walls, thereby permitting convenient hanging and securing the hanger from dislodgement due to wind, rain, or other factors.

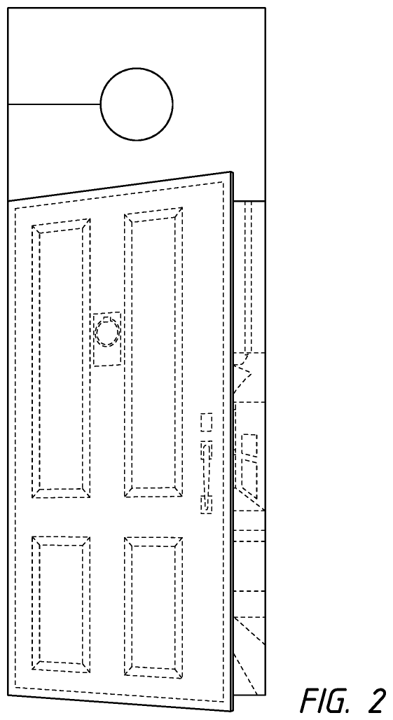

FIG. 2 illustrates an embodiment of the present invention in a partially unfolded state, where the opener begins to revel the information or image printed on the internal panels. This “unfolding” of the information, which may be hinted at by the front display panel, may lead to higher engagement with the message or information that is “hidden” in the folded state.

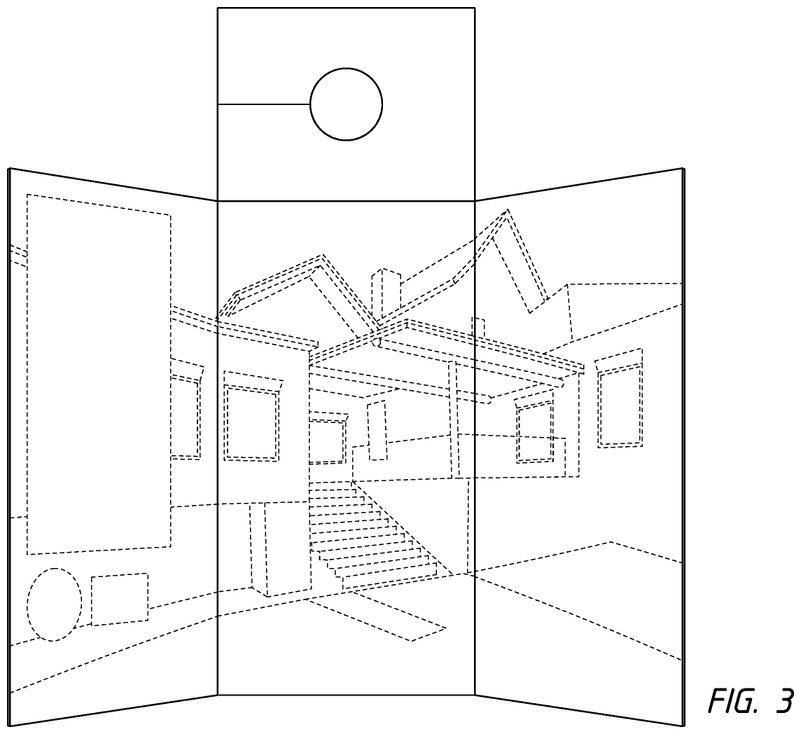

FIG. 3 illustrates an embodiment of the present invention in an unfolded state, where a large format image or other display is presented to the recipient. In another embodiment of the invention, the blank hanger portion of the door hanger can be printed with relevant information or images or with an additional portion of the image or information printed on the panels.

In still another embodiment, the upper potions of the side panels need not be cut away from the sheet and can be retained as additional hanging sections with side cuts and middles removed. This embodiment can be produced by using a stamp or cutter on a folded version of the sheet so that, for example, three hanging portions are fabricated.

Modifications and substitution by one of ordinary skill in the art are considered to be within the scope of the present invention, which is not limited except by the following claims.

What is claimed is:

1. An expandable door hanger comprising:
an upper hanging portion with a slit leading to a void for hanging on a door knob or handle;
a lower portion comprising two or three panels, one of which is contiguous with the upper section;
where the other lower panel and panels are foldable over or around the lower panel contiguous with the upper portion to form an expandable door hanger.

2. An expandable door hanger according to claim 1, where the folded panels are secured with glue, a sticker, hook and loop fastener, or other fastener.

3. An expandable door hanger according to claim 1, where the folded panels are of approximately equal width with the hanging portion.

4. An expandable door hanger according to claim 1, where the hanging portion is above one of the side panels.

5. An expandable door hanger according to claim 1, made from paper stock between 65 and 80 lbs.

6. An expandable door hanger comprising:
an upper hanging portion with a slit leading to a void for hanging on a door knob or handle;
a lower portion comprising three panels, each of which is contiguous with the upper portion;
where the lower panel or panels are foldable over or around one another, and where each lower panel is contiguous with its own upper hanging potion.

7. An expandable door hanger according to claim 6, where the folded panels are secured with glue, a sticker, hook and loop fastener, or other fastener.

8. An expandable door hanger according to claim 6, where the folded panels are of approximately equal width with the hanging portion.

9. An expandable door hanger according to claim 6, made from paper stock between 50 and 80 lbs.
